(19) United States
(12) Patent Application Publication
(10) Pub. No.: US 2026/0365472 A1
(43) Pub. Date: Nov. 19, 2026

(54) NON-PERFORATING SHEET FOLDING APPARATUS, STACK MAKING DEVICE AND METHOD, AND STOCK MATERIAL

(71) Applicant: YCD Green Packaging Technology Company Limited, Foshan (CN)

(72) Inventor: Wuming ZHENG, Foshan (CN)

(21) Appl. No.: 19/677,396

(22) Filed: May 14, 2026

Related U.S. Application Data
(60) Provisional application No. 63/806,894, filed on May 16, 2025.

(51) Int. Cl. B65H 45/20; B65H 45/101

(52) U.S. Cl. CPC B65H 45/20; B65H 45/101; B65H 2301/4216; B65H 2404/1421; B65H 2701/11231; B65H 2701/1211

(57) ABSTRACT

A non-perforating sheet folding apparatus, a stack making device and method, and stock material. The sheet folding method includes: providing two rollers arranged in parallel; forming a conveying channel between the two rollers; and the rollers clamps and rotates the sheet in the conveying channel to convey the sheet downstream and produce a stack of the folded sheet in a zigzag shape, wherein one roller floats relative to the other roller, so that a distance between the two rollers changes in response to a thickness variation of the sheet. The rollers exert tension on the sheet to keep the sheet in a proper tension state. By adjusting the distance of the rollers in response to the thickness variation of the sheet, the force exerted by the rollers on the sheet is maintained in a proper range, and the risk of tearing the sheet in the folding process is reduced.

### RELATED APPLICATIONS

This application claims the benefit of U.S. Provisional Application No. 63/806,894 filed May 16, 2025, the contents of which are expressly incorporated herein by reference.

### TECHNICAL FIELD

The present application relates to the field of stock materials for packaging applications such as buffering, void filling, wrapping, and other packaging applications, and in particular to a non-perforating sheet folding apparatus, a stack making device and method, and stock material.

### BACKGROUND

Paper stock materials are used in many applications related to packaging and of protection of products. Due to the large quantity of stock materials required, it is essential to ensure the maximum supply of stock materials in a single feeding session.

In related arts, stock materials are supplied in the form of rolls. Increasing the total length of the buffer material roll increases its inertia, making it prone to excessive tension during processing which may cause tearing. Therefore, it is necessary to balance the tension of the roll, which requires complicated design work on structures. For example, U.S. Patent US11780202 B2 describes the use of friction rods and other related structures to allow for the processing of stock materials at a constant tension.

Complex designs are required to balance the tension of the roll. In other related arts, such as European Patent EP1565307A2, stock materials are provided in a stacked manner, allowing users to extract the buffer material without having to overcome the inertia of the roll, thereby reducing the risk of tearing.

During the stack making process, perforations are often made on a raw sheet to create crease lines that facilitate folding. However, these perforations weaken the strength of the sheet, increasing the risk of tearing during production and processing the sheet material through a packaging dispenser. To address this issue, European Patent EP1896250A1 is with an improved perforation ratio and US10604323B2 propose various optimization designs for such perforations, but they cannot completely eliminate negative impact of perforations.

Some related arts propose folding methods that do not require perforations. For example, in German application DE19803837A1, and Patent US9061860B2, EP Patent EP2605988B1 and China Utility Model CN101443253A, a sheet is folded using two opposing rollers, one roller pushes the sheet towards a clamping board on the other roller via an insert strip, and then the sheet is clamped and folded by means of the clamping board.

In typical cases of making end-less fanfold bundles there is a need to splice the bundles together, refer to DE202014008810U1 and EP1565307A2. The average bundle depth is between 8.5 and 11 inch and stacked in rows of 4 to 5 bundles on a pallet. The disadvantage of these bundles is tipping.

During this process, the insert strip alters the convey route of the sheet by applying tension to it. If insert strip exerts too much force on the sheet, there remains a risk of tearing the sheet.

In addition, the currently produced stacks are of a small size, resulting in a short total length of buffer material in each stack, which can be inconvenient for use. If the height of the stack is increased, it is easy for the stack to fall down during processing.

A disadvantage of having a perforation weakness in a sheet stock material is that the sheet can tear at the perforation while processing, for example, into a packaging material. Thus, the processing speed of sheet materials is limited due to perforation weakness. In addition, due to changes in ecological and economical needs, the availability of Virgin papers, which have long strong fibers, is decreasing, whereby the need to use Recycle fiber materials and papers with even higher recycle content, such as Fluting papers, is increasing. Due to the shorter fibers in these recycle materials the sheets of material are even weaker and vulnerable to tearing easily if processed at high speeds, especially when the sheet material is provided with any perforations.

In addition, substantial perforations in sheet stock material, such as is common in the prior art, increases the amount of dust and debris in contact with the stacked sheet stock, and causes slipping or unfolding of the fan-fold sheet stock material from the bundle.

### SUMMARY

The present application aims to solve at least one of the technical problems existing in the related art. To this end, the present application proposes a non-perforating sheet folding apparatus, a stack making device and method, and stock material. The sheet folding apparatus is capable of reducing downtimes during production of the stock material and also reducing the risk of tearing of a sheet during folding. And allows processing the stock materials on higher speed and with higher tension.

The sheet folding method provided by the application includes two rollers arranged in parallel, and a conveying channel is formed between the rollers. The two rollers clamp the sheet in the conveying channel, and the rollers rotate to convey the sheet downstream and the sheet is folded in a shape of a zigzag pattern. One of the rollers can float relative to the other roller, so that a distance between the two rollers changes in response to the thickness change of the sheet. This can also adapt to sheets with relatively poor quality and relatively low cost. Usually, the impurities on such sheets are more likely to cause changes in their thickness.

According to the sheet folding method provided by the application, at least the following technical effects are achieved: the rollers exert tension on the sheet to keep the sheet in a proper tension state, and the distance between the rollers is adjusted in response to the thickness change of the sheet, so that the acting force of the rollers on the sheet is maintained in a proper range, and the risk of tearing of the sheet in the folding process is reduced.

According to some embodiments of the present application, the tension applied to the sheet by the rollers does not exceed the tensile strength of the sheet.

According to some embodiments of the present application, the rollers include a first roller and a second roller. As the rollers rolling, a push component of the first roller pushes the sheet in the conveying channel into a clamp component of the second roller, and a push component of the second roller pushes the sheet in the conveying channel into a clamp component of the first roller.

According to some embodiments of the present application, the clamp component and the push component may be equipped with damping materials, such as using damping rubber strips, which may effectively reduce the noise caused by collision of the clamp components.

According to some embodiments of the present application, at least one of the cam and roller for pushing the clamp component and the push component may adopt noise-reducing and shock-absorbing materials, which may effectively reduce the noise generated by the collision between the cam and the roller.

According to some embodiments of the present application, when the sheet is being pushed in toward the clamp component by the push component, the push component protrudes relative to the circumferential surface of the rollers, and after the sheet is pushed in and clamped in place by the clamp component, the push component retracts relative to the circumferential surface of the rollers.

According to some embodiments of the application, before entering the conveying channel, a slit is made on the sheet, and the slit is inclined to a length direction of the sheet.

According to some embodiments of the present application, the sheet forms a stack after being folded.

The sheet folding apparatus provided by the present application includes rollers and a first elastic member. The two rollers are disposed in parallel and opposite each other in a horizontal direction. A conveying channel is formed between the rollers to enable the sheet to pass through. At least one of the rollers is movable in the horizontal direction to be close to or away from the other roller. The rollers are used for folding the sheet passing through the conveying channel to form a stack of a zigzag shape. The first elastic member is connected to the movable roller and used for driving one roller to move toward the other roller.

According to some embodiments of the present application, the rollers include a movable first roller and a fixed second roller.

According to some embodiments of the present application, the sheet folding apparatus includes a frame, a fixed plate and a movable plate. The movable plate is movably disposed on the frame, the first roller is rotatably disposed on the movable plate, the fixed plate is fixedly disposed on the frame, and the second roller is rotatably disposed on the fixed plate.

According to some embodiments of the present application, the sheet folding apparatus includes a support plate. The support plate is disposed on the frame, a position of the support plate is adjustable in the horizontal direction. The first elastic member is disposed between the support plate and the movable plate.

According to some embodiments of the present application, the sheet folding apparatus includes a first limit component located on a side, close to the second roller, of the movable plate, and the first limit component is arranged to abut against the movable plate such that a distance between the first roller and the second roller is not less than a preset lower threshold.

According to some embodiments of the present application, the sheet folding apparatus includes an alarm component. The alarm component includes a first limit switch disposed on a travel of the movable plate, and the first limit switch is capable of generating an alarm signal in response to a distance between the first roller and the second roller exceeding a preset upper threshold.

According to some embodiments of the present application, the alarm component includes a second limit switch. Each of the rollers is provided with an annular groove along its circumference. The second limit switch faces the annular groove, and the second limit switch is capable of generating an alarm signal in response to the sheet being wrapped around the roller.

According to some embodiments of the present application, the sheet folding apparatus includes transmission gears mounted on each of the rollers. The two transmission gears mesh with each other. A tooth height of the transmission gear is greater than a movement range of the roller.

According to some embodiments of the present application, the sheet folding apparatus includes a carrier platform and forks. The carrier platform is located below the rollers and arranged to receive the folded sheet to form a stack, and the two forks are disposed on two sides of the carrier platform oppositely in the horizontal direction and used for alternately applying a force to edges of the stack.

According to some embodiments of the present application, the sheet folding apparatus includes a synchronization component through which the forks are connected to the rollers, allowing the movement of the forks to be coupled with the rotation of the rollers.

According to some embodiments of the present application, the sheet folding apparatus includes rotatable second shafts extending parallel to the rollers, and the forks are disposed on the second shafts.

According to some embodiments of the present application, the synchronization component includes a cam, a link mechanism and a second elastic member. The cam is disposed on the roller, the link mechanism is disposed on the second shaft, and the second elastic member is arranged to drive the link mechanism to abut against the cam, so as to enable the second shaft to rotate in response to the rotation of the cam.

According to some embodiments of the present application, the link mechanism includes a first link and a second link. The first link is fixedly disposed on the second shaft, the second link is rotatably disposed on the frame, the second link abuts against the cam, and the first link and the second link are slidably connected.

According to some embodiments of the present application, a distance from a position where the second link abuts against the cam to a rotational shaft of the second link is defined as a first distance, a distance from a position where the second link is connected to the first link to the rotational shaft of the second link is defined as a second distance, and the second distance is larger than the first distance.

According to some embodiments of the present application, the roller is provided with an annular groove along its circumference. The annular groove is located to be aligned with a position of the fork, and the second elastic member is arranged to drive an end of the fork to extend into the annular groove, allowing the fork to push the sheet out when being compressed.

According to some embodiments of the present application, the fork is elastically deformable to compensate for the changes in the distance between the stack and the roller and the amount of deformation caused by the variation of tightness of the stack.

According to some embodiments of the present application, the fork is movably disposed on the second shaft. The sheet folding apparatus includes a third elastic member disposed between the fork and the second shaft, and the third elastic member is used for providing a compression force.

According to some embodiments of the present application, the fork generates a compression force against the sheet in a range of 0.2 kgf to 10kgf, preferably 0.5 kgf to 10kgf, and more preferably 0.5 kgf to 5 kgf.

According to some embodiments of the present application, the sheet folding apparatus includes a shaping plate encircling the carrier platform, and the shaping plate is arranged to limit and shape the stack.

According to some embodiments of the present application, the sheet folding apparatus defines a manufacturing chamber, the carrier platform and the shaping plates are located in the manufacturing chamber. The sheet folding apparatus further includes a movable door panel capable of opening or closing the manufacturing chamber, and the shaping plate located is disposed on the door panel, that is, on the same side of the door panel.

According to some embodiments of the present application, the sheet folding apparatus includes a first convey component disposed upstream of the roller for conveying the sheet to the roller.

According to some embodiments of the present application, a frictional force applied by the first convey component to the sheet does not exceed a tensile strength of the sheet.

According to some embodiments of the present application, the frictional force applied by the first convey component to the sheet is controlled by at least one of the following ways: adjusting a skin friction coefficient of the first convey component; adjusting a contact area between the sheet and the first convey component; adjusting a force that presses the sheet against the first convey component. At the same time, the sheet may generate sliding friction on the first convey component.

According to some embodiments of the present application, the sheet folding apparatus includes a buffer and a fourth elastic member. The fourth elastic member is used for making the buffer resiliently press against the sheet to buffer or release the sheet in response to a change in tension of the sheet.

According to some embodiments of the present application, before the sheet enters the buffer, there is at least one third convey component, which pulls the sheet, such that sliding friction occurs between the sheet and the third convey component. In this case, the friction force applied by the third convey component to the sheet does not exceed a tensile strength of the sheet.

According to some embodiments of the present application, the sheet folding apparatus includes a plurality of guide rollers and a second convey component. The plurality of guide rollers are located upstream of the first convey component, and inclined from bottom to top along a convey route of the sheet to form an upwardly inclined feeding channel. The second convey component is capable of moving close to or away from the guide rollers, and the second convey component is used for driving the sheet to be conveyed along the feeding channel.

According to some embodiments of the present application, the sheet folding apparatus includes deflectors extending between every two adjacent guide rollers. The deflectors are located below a conveying surface defined by the two adjacent guide rollers.

The stack making device provided by the present application includes a feeding apparatus and the sheet folding apparatus provided by the present application, and the feeding apparatus is used for supplying the sheet to the sheet folding apparatus.

The sheet folding apparatus and the stacking making device provided by the application can be used for implementing the sheet folding method provided by the application, so the stack making device and the sheet folding apparatus will correspondingly have the beneficial effects provided by the sheet folding method, which are not repeated here.

The stack of sheets provided by the present application includes a sheet extending in a length direction. The stack is formed by folding the sheet at a predetermined intervals along its length, about crease lines that are orthogonal to the length direction, thereby producing a zigzag pattern stack made of crease lines without perforations, or, with perforations, particularly the ratio of a length occupied by the perforation slits to the total length of a crease line and is less than or equal to 10%.

The stack of sheets provided by the present application has at least the following technical effects: by adopting the design that the crease line is not perforated or with substantial less perforations compared to prior art, the tensile strength of the sheet can be effectively improved, so that the stack of the sheets provided by the application has the advantage of being difficult to tear. Compared with the sheet material being rolled, it is beneficial to have the sheets being stacked when it comes to sheet processing, since the stack way can reduce the influence of inertia on sheet processing, and the force required for sheet processing at the same speed can also be reduced, so that the stack of sheets provided by the application is suitable for being extracted at a higher speed. The stack of sheets provided by this application is especially suitable for paper with high recycling content, that has shorter paper fibers and lower technical tearing strength.

According to some embodiments of the present application, the stack has a height less than or equal to 3 times the predetermined interval, preferably less than or equal to 2.5 times the predetermined interval, and more preferably less than or equal to 2 times the predetermined interval.

According to some embodiments of the present application, a width of the stack is 300 mm to 1200 mm whereby the length L of a stack is 280 mm to 1200mm, preferably greater or equal to 500mm.

According to some embodiments of the present application, the sheet includes expansion lines inclined to crease lines of the sheet. The expansion lines are disposed at an interval in the length direction, the expansion lines have slits thereon that penetrate the sheet. The slits of adjacent expansion lines are arranged in an offset manner.

### BRIEF DESCRIPTION OF THE DRAWINGS

The accompanying drawings are used to provide a further understanding of the technical schemes of the present disclosure and constitute a part of the description. The accompanying drawings are used to explain the technical schemes of the present disclosure together with the embodiments of the present disclosure, and do not constitute a restriction on the technical schemes of the present disclosure.

FIG. 1A is a schematic diagram showing a sheet stock material in the form of a fan-fold sheet stack according to an embodiment of the present application;

FIG. 1B is a partial view of a sheet material of the present disclosure showing a crease line with no perforations;

FIG. 1C is a partial view of a sheet material of the present disclosure showing a crease line with slit-like perforations on opposite end portions of the crease line;

FIG. 1D is a partial view of a sheet material of the present disclosure showing a crease line with slit-like perforations symmetrically spaced apart along the crease line;

FIG. 1E is a partial view of a sheet material of the present disclosure showing a crease line with slit-like perforations randomly spaced apart along the crease line;

FIG. 1F is a partial view of a sheet material of the present disclosure showing a crease line with punch-hole perforations spaced apart along the crease line;

FIG. 2 is a schematic diagram of the stack of sheets according to an embodiment of the present application during processing of the sheets by a conversion machine (e.g., a dunnage machine or other processing machine for converting the stock material of the stack of sheets into packaging material), which shows that the stack of sheets is more stable and not easy to topple;

FIG. 3 is a schematic structural view of an expandable material made from the sheet of the present application;

FIG. 4 is a simplified schematic diagram showing two opposite rollers of the present disclosure cooperating throughout multiple steps in generating a fan-fold sheet stack;

FIG. 5 is an enlarged schematic structural view of the two cooperating rollers of FIG. 4, also illustrating positions of the fork components relative to the rollers, with a first illustrated fork component (on the left side of the illustration) having an end portion disposed within an annular groove of a corresponding roller, and with the opposite fork component (on the right side of the illustration) having an end portion that has exited an annular groove of its corresponding roller;

FIG. 6A is a schematic structural view of a sheet folding apparatus according to an embodiment of the present application, in which one of configurations of rollers is illustrated;

FIG. 6B is a schematic structural view of a sheet folding apparatus according to an embodiment of the present application, in which one of configurations of driving rollers is illustrated;

FIG. 7 is a schematic structural view of a sheet folding apparatus according to an embodiment of the present application, in which one way of conveying a sheet to a roller is illustrated;

FIG. 8A is a schematic structural view of a sheet folding apparatus according to an embodiment of the present application, in which a design structure of a roller is shown;

FIG. 8B is a structural schematic view of a sheet folding apparatus according to an embodiment of the present application, in which one of configurations of the clamping assembly and a damping material is shown;

FIG. 8C is a structural schematic view of a sheet folding apparatus according to an embodiment of the present application, in which one of configurations of the cam and the roller is shown;

FIG. 8D is a structural schematic view of a sheet folding apparatus according to an embodiment of the present application, in which one of configurations of the cutter is shown;

FIG. 9 is a schematic structural view of a sheet folding apparatus according to an embodiment of the present application, in which another design structure of a roller is shown;

FIG. 10A is a schematic structural view of a sheet folding apparatus according to an embodiment of the present application, in which one of configurations of a fork is illustrated;

FIG. 10B is a simplified perspective view of a first fork component of FIG. 5 of the present disclosure, in an open position (the end portion of first fork component may be partially or fully positioned within an annular groove of the first roller in this position, but the first roller is not shown in this simplified perspective view);

FIG. 10C is a simplified perspective view of a second fork component of FIG. 5 of the present disclosure, opposite the first fork component, in a downward position (in this downward position, the end portion of the second fork component has exited the annular groove of the second roller, but the second roller is not shown in this simplified view);

FIG. 10D is a simplified perspective view of the second fork component of FIG. 10C, in an open position, which is a position that the second fork component alternates to and from, relative to its position shown in FIG. 10C (the end portions of second fork component may be partially or fully positioned within an annular groove of the second roller in this open position, but the second roller is not shown in this simplified perspective view); and

FIG. 11 is a schematic structural view of a sheet folding apparatus according to an embodiment of the present application, in which one of configurations of a door panel is illustrated.

### DETAILED DESCRIPTION

Embodiments of the present application will be described in detail below. Examples of the embodiments are illustrated in the accompanying drawings, where the same or like reference numerals throughout the figures indicates the same or like elements having the same or like functions. The embodiments described below with reference to the accompanying drawings are exemplary and are intended only to explain the present application instead of being construed as limiting the present application.

In the description of the present application, it should be understood that, descriptions relating to orientation, for example, orientation or positional relationships indicated by up, down, front, rear, left, right, etc. are based on the orientation or positional relationships shown in the accompanying drawings, and are to facilitate the description of the present application and simplify the description only, rather than indicating or implying that the device or element referred to must have a specific orientation or be constructed and operated in a specific orientation, and therefore cannot be construed as limiting the present application.

In the description of the present application, the meaning of “several” is one or a plurality; the meaning of “a plurality of” is two or more; “greater than”, “less than”, “more than”, etc. are to be construed as excluding a given figure; and “above”, “below”, “within”, etc. are to be construed as including a given figure. If “first” and “second”, etc. are referred to, it is only for the purpose of distinguishing technical features, and shall not be construed as indicating or implying relative importance or implying the number of the indicated technical features or implying the sequence of the indicated technical features.

In the description of the present application, unless otherwise explicitly defined, the terms such as “arrange”, “install”, and “connect” should be construed in a broad sense, and those skilled in the art can determine the specific meanings of the above terms in the present application in a rational way in conjunction with the specific contents of the technical schemes.

In this specification, the description with reference to terms such as “one embodiment”, “some embodiments”, “example embodiments”, “example”, “specific example”, and “some examples” means that the specific features, structures, materials or features described in conjunction with the embodiment(s) or example(s) are included in at least one embodiment or example of the present application. In the description, the illustrative expressions of the above-mentioned terms do not necessarily refer to the same embodiments or examples. Moreover, the specific features, structures, materials or characteristics described can be combined in any one or more embodiments or examples in any suitable manner.

Providing stock materials in a stacked form to users may eliminate the effects of inertia and reduce the risk of tearing during processing. However, the process of converting a roll into a stack requires folding the sheet, which also carries the risk of accidental tearing. Moreover, when folding, it is often necessary to make perforations at the crease line, which will weaken the tensile strength of the sheet and enlarge the risk of tearing.

Expandable material is a special type of buffer material that, under tensile force, can expand and transform from a two-dimensional plane state to a three-dimensional state through its own slits, offering better packaging results. During the process of creating a stack of expandable materials, slits need to be made on a sheet before folding, which weakens the tensile strength of the sheet and further increases the risk of accidental tearing during production.

The application provides a stack of sheets, specifically, the stack is made of sheet 9000.

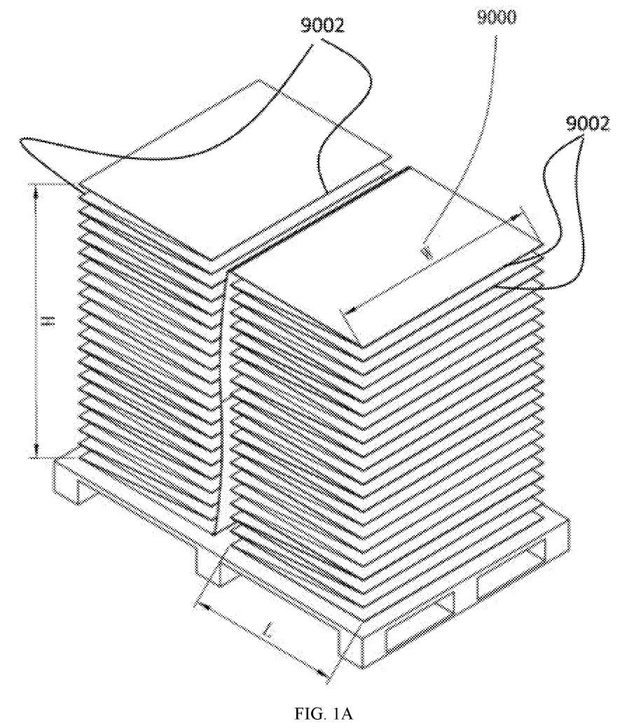

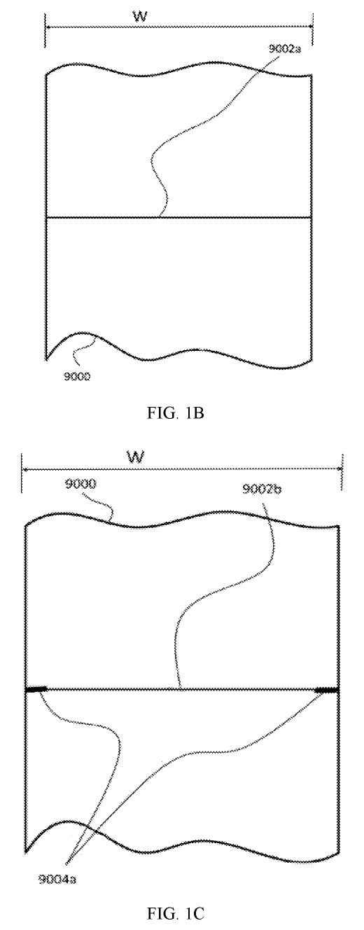

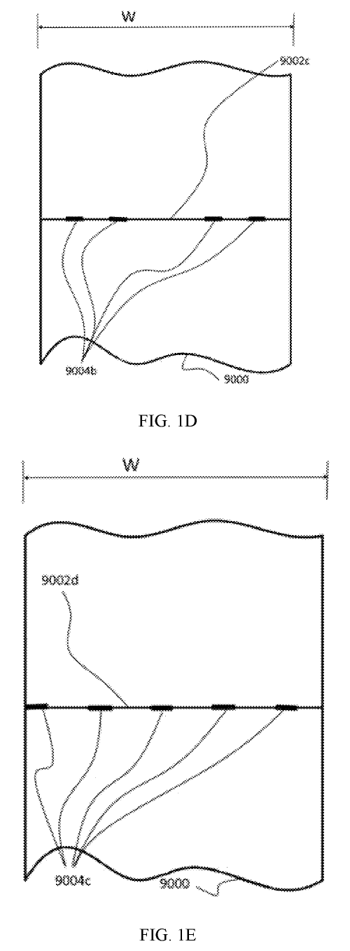

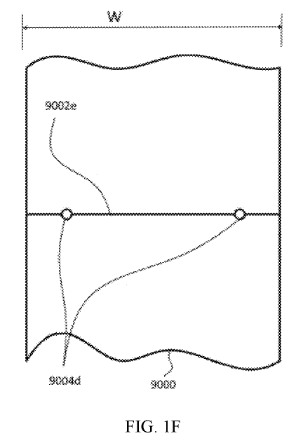

Referring to FIGS. 1A, 1B, 1C, 1D, 1E, and 1F, a sheet 9000 extends along its own length L direction (that is, the longitudinal direction), and the sheet 9000 is folded in a zigzag pattern at a preset interval along fold creases that extend in a direction orthogonal to the length L direction (that is, the transverse direction) to form a stack. The crease lines 9002 of the sheet 9000 is substantially free of perforation.

Specifically, the term of "substantially free of perforations" is defined as including the following two situations: one is that the crease line has no perforation at all; and the other is that although the crease line has perforation, the perforation accounts for a very low proportion in the crease line, namely, the aggregate length of the weakening by cuts or punch holes relative to the crease line in the paper is less than 10%, or preferably less than 5%, of the entire crease line length, or in other words, the width W of the sheet material, which has low or negligible impact on strength.

For example, referring to FIG. 1B, in some embodiments of present disclosure, the crease line 9002a is completely free of perforations. Referring to FIG. 1C, in other embodiments, the crease line 9002b may have perforations 9004a in the form of slit-like cuts, provided only at opposite end portions thereof, and such perforations may have a length along the crease lines of between about 5 mm to about 50 mm in length each, but wherein the aggregate length of both perforation lines 9004a along the width W consists of less than 10% of the total width W of the crease line. Referring to FIG. 1D, in other embodiments, the crease line 9002c may be provided with symmetrically spaced-apart perforations 9004b in the form of slit-like cuts, with similar distances between each such perforation lines 9004b. Referring to FIG. 1E, in other embodiments, the crease line 9002d, may be provided with perforations lines 9004c that are randomly spaced apart, and may be shaped in the form of slit-like cuts, and may have random lengths along the crease line 9002d. Referring to FIG. 1F, in other embodiments, the crease line 9002e, may be provided with perforations 9004d in the form of punch holes, located at spaced apart positions along the crease line 9002e, rather than slit-like cuts. In each of the perforation configurations of FIGS. 1B-1E, the perforations may also be formed in the shape of punch holes, with such punch holes being circular in shape. Also, in each of the embodiments shown in FIGS. 1B-1F, the aggregate length of the perforations 9004a, 9004b, 9004c, 9004d relative to the crease lines 9002b, 9002c, 9002d, and 9002e, may be less than 10% of the width W (or crease line length), or less than 5% of the width W. Note that the perforations as shown in the drawings are simplified illustrations and may not show actual scale of the perforation length relative to the crease line length or width W. In some embodiments, the stack of sheets adopts the design that the crease lines are substantially free of perforations, which reduces the weakening effect of the crease lines on the sheet 9000 and can effectively improve the tensile strength of the sheet 9000, so that the stack of sheets provided by the application has the advantage of being difficult to tear.

Also, by providing the sheet 9000 in a stacked manner, the influence of inertia on the sheet 9000 is reduced, when compared with feeding sheet material via a roll, and the force required for processing each folded sheet section at the same speed can be reduced, so that the stack of sheets provided by the application is suitable for being extracted at a higher speed.

Also, based on the above advantages, the sheet 9000 of this application is allowed to be made of recycled paper with high recycling content, that is, the paper fibers are shorter and the technical tearing strength of the paper quality is lower, which expands the raw material range of the sheet 9000 and has unique advantages in manufacturing cost and environmental protection.

Moreover, based on the advantages of the crease lines being substantially free of perforations and the sheet 9000 being fed in a stacked manner without the use of a roller to feed the sheet material, the stack of sheets in use is not easy to tear during processing, thus effectively reducing the machine downtime of the dunnage machine.

The height of the stack can be less than or equal to 3 times the predetermined interval, preferably less than or equal to 2.5 times the predetermined interval, and more preferably less than or equal to 2 times the predetermined interval.

For example, when the height of the stack is 1.5m, the preset interval should be greater than 0.5m. The preset interval is defined as the length of each layer of sheet 9000 in the stack, and can be regarded as the length L of each folded section of the stack. Using an appropriate preset interval can avoid the stack from toppling when in use.

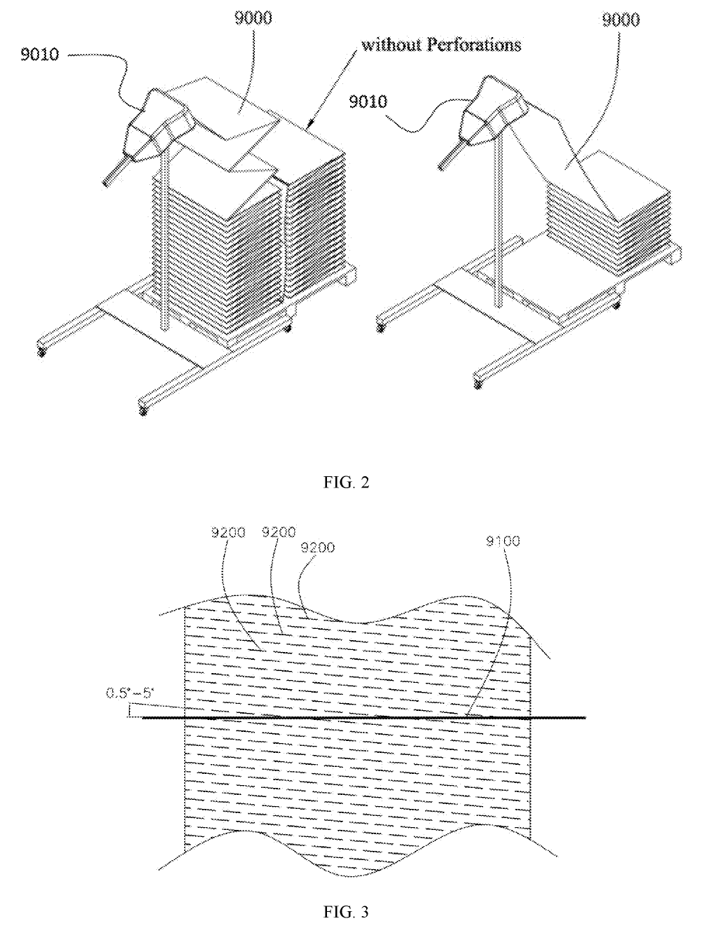

Specifically, refer to FIG. 2, this design allows two stacks to be placed side by side for processing in a processing machine 9010 (e.g., a dunnage machine, or other processing machine for processing the stock material of stacked sheets into a packaging material), and the stacked sheet 9000 are continuously connected together. After the processing of one stack is completed, the dunnage machine can continue the processing of the next stacked sheet 9000, which effectively improves the processing efficiency of the sheet 9000.

In order to increase the total length of the sheet 9000 in a single stack, a length L of each folded section can be set to 280mm to 1200mm, preferably 400mm to 1200mm, and more preferably 500mm to 1200mm, which is much larger than the standard value 280mm commonly used in related technologies, which is helpful to make a higher stack and increases the total length of the sheet 9000 in a single stack.

The specific length of the stack can be flexibly selected according to a size of the platform for loading the stack. For example, in the case of loading the stack with a card board, the length of the stack can be close to the length of the card board or half the length of the card board, that is, one card board can places one or two stacks, making full use of the bearing space of the card board, thus producing a large-size stack that is convenient to use and transport.

Alternatively, a width W of the sheet itself is 300mm to 1200mm, preferably 400mm to 1200mm, and more preferably 500mm to 1200 mm.

It can be understood that the present application can provide a stack of ordinary cushioning materials as well as a stack of expandable materials.

In the latter case, referring to FIG, 3, for example, the sheet 9000 includes an expansion line, which is inclined to the crease line 9100 of the sheet 9000 (in the embodiment shown in FIG. 3, the included angle between the expansion line and the crease line 9100 is between the 0.5° and 5°. The expansion lines are arranged at intervals along the length direction, and the expansion lines have slits 9200 penetrating through the sheet 9000. The slits 9200 of adjacent expansion lines are staggered.

In addition to the stack of expandable materials with intersecting expansion lines and crease lines 9100, the present application can also provide a stack of expandable materials with parallel expansion lines and crease lines 9100.

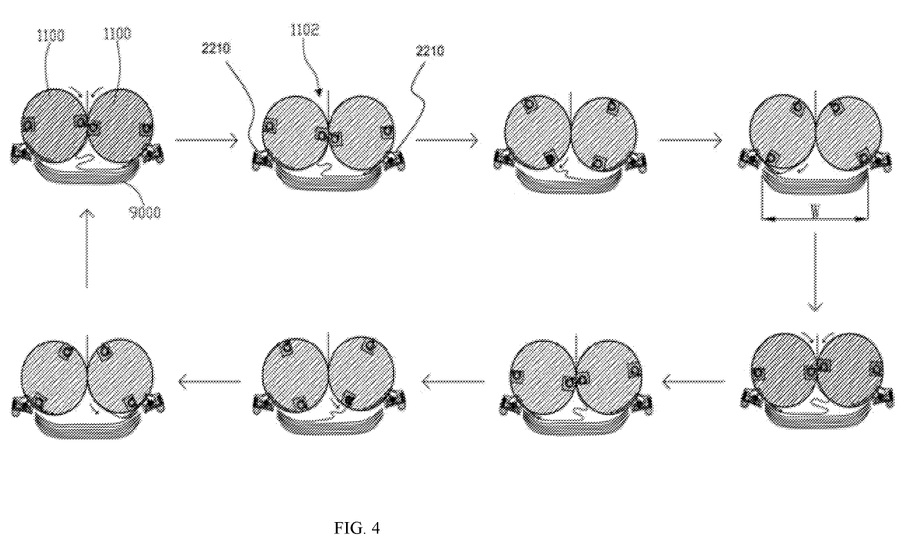

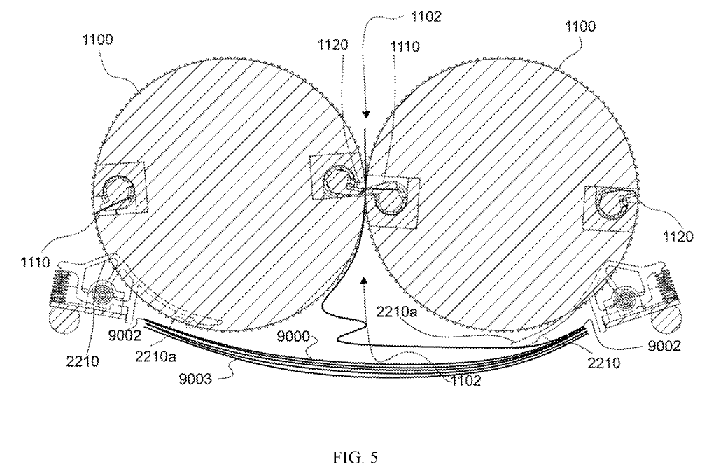

Referring to FIG. 4, in some embodiments of the present disclosure, two rollers 1100 include a first roller and a second roller, and a conveying channel 1102 is formed between the two rollers 1100. Referring to FIG. 5, during the folding process, the push component 1110 of the first roller pushes the sheet 9000 in the conveying channel 1102 into the clamp component 1120 of the second roller. After the push component 1110 leaves the clamp component 1120, the clamp component 1120 clamps the sheet 9000, and the second roller moves the sheet 9000 to the left, forming a positive crease line on the sheet 9000. Then, the clamp component 1120 releases the sheet 9000. Similarly, the push component 1110 of the second roller pushes the sheet 9000 in the conveying channel 1102 into the clamp component 1120 of the first roller. After the push component 1110 leaves the clamp component 1120, the clamp component 1120 clamps the sheet 9000, and the first roller moves the sheet 9000 to the right, forming a reverse crease line on the sheet 9000. Then, the clamp component 1120 releases the sheet 9000. With the rotation of the rollers 1100, the push components 1110 of the two rollers 1100 alternately act on the sheet 9000, thus making the sheet 9000 to form a zigzag stack.

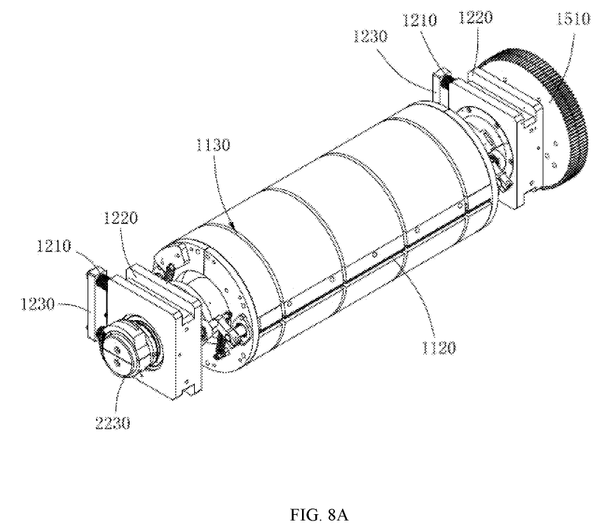

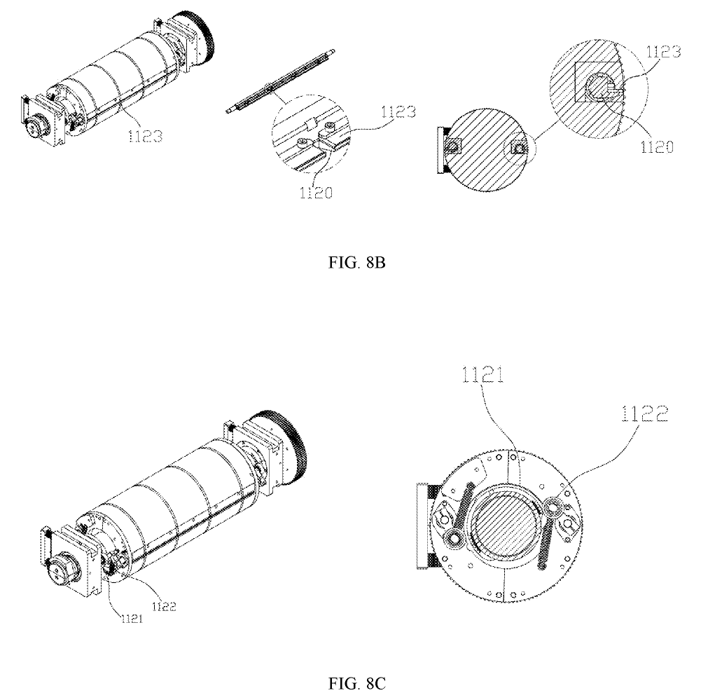

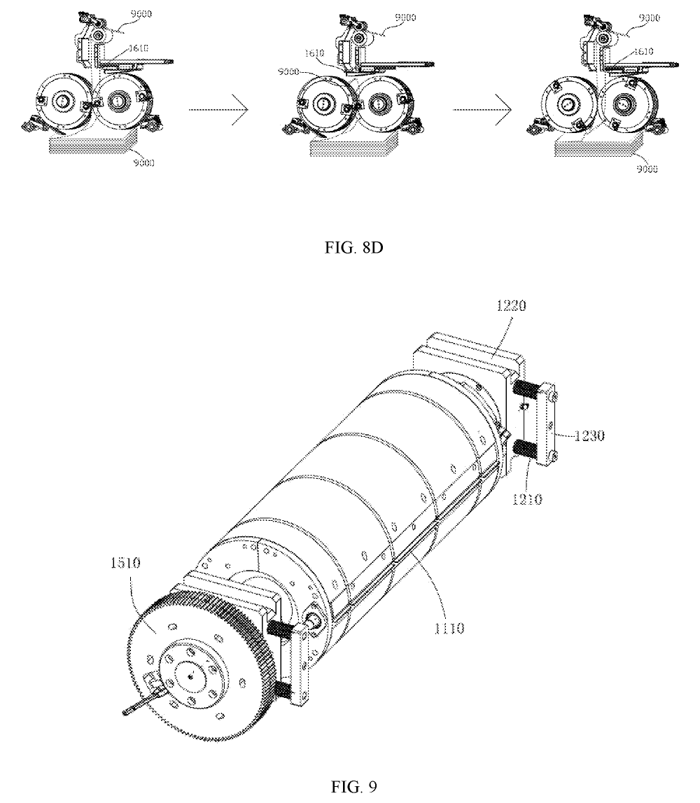

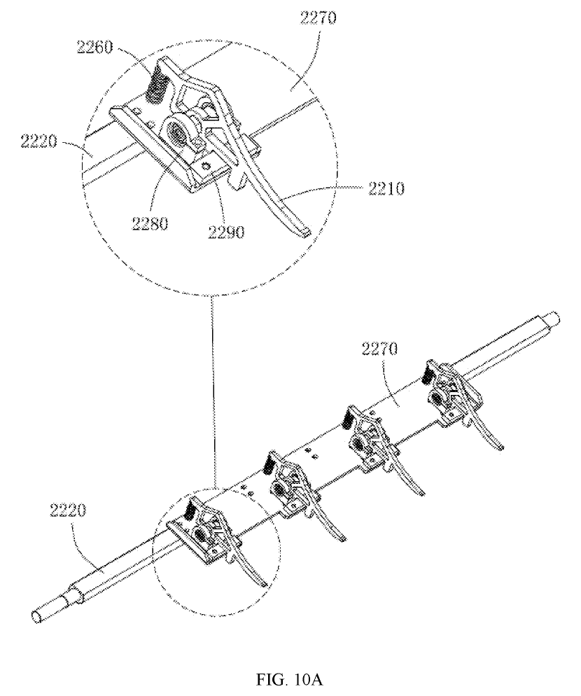

In the design of the application, it is also considered to make the components have the functions of noise reduction and shock absorption. Referring to FIGS. 8B and 8C, firstly, a noise-reducing and shock-absorbing material 1123 may be used in the clamp component 1120, and secondly, in the structure of the cam 1122 and the roller 1121 for pushing the clamp component and the push component, at least one of the cam 1122 and the roller 1121 is made of noise-reducing and shock-absorbing material.

In the sheet folding method of the present application, the circumferential surfaces of the two rollers 1100 are in contact with the sheet 9000, and the two rollers 1100 clamp the sheet 9000 in the conveying channel 1102 to apply tension to the sheet 9000. In this way, during the release of the sheet 9000 by the clamp component 1120, the sheet 9000 can also be properly tensioned. That is, the rollers 1100 do not merely rely on the clamp component 1120 to apply tension to the sheet 9000.

As will be understood by those of ordinary skill in the art, a challenge of this design lies in the need to control the maximum friction between the circumferential surface of the rollers 1100, and the sheet 9000 in an appropriate range. If the maximum friction is too small, it is difficult to provide an appropriate tension. If the maximum friction is too large, the sheet 9000 cannot slip on the circumferential surface when the push component 1110 acts on the sheet 9000, and the tension on the sheet 9000 will exceed the tensile strength of the sheet 9000, resulting in the tearing of the sheet 9000.

Some sheets 9000 (such as recycled paper) used to make cushioning materials have low tensile strength and fluctuating thickness, which further increases the risk of accidental tearing of the sheet 9000 during the manufacturing process.

To this end, the present application provides a sheet folding method for folding a sheet 9000 into a stack while minimizing the risk of accidental tearing during the folding process.

The folding method of the sheet provided by the present application comprises the following steps: arranging two rollers 1100 in parallel, and a conveying channel 1102 is formed between the rollers 1100; clamping the sheet 9000 in the conveying channel 1102 by the rollers 1100, and the rollers 1100 rotates to convey the sheet 9000 downstream and the sheet 9000 is folded to form a zigzag stack; and one of the rollers 1100 is capable of floating relative to the other roller 1100, so that a distance between the two rollers 1100 changes in response to a thickness change of the sheet.

The sheet folding method of the present application is suitable for manufacturing non-perforated cushioning materials provided in a stacked form. FIG. 2 show a sheet made by the device, which has no perforation. It is necessary to process perforated paper at a lower processing speed, otherwise the paper is easy to tear, especially the paper with high recycling content/short paper fibers. The device of the present application can improve the productivity by folding the sheet into folded paper without any perforation, which is 20% to 200% faster than processing perforated paper.

Specifically, in the sheet folding process of the present application, the rollers 1100 clamp the sheet 9000 from the thickness direction, so as to apply tension to the sheet 9000 during the rotation process, so as to keep the sheet 9000 in a proper tension state; and by adjusting the spacing of the rollers 1100 in response to the thickness change of the sheet 9000, the acting force of the roller 1100 on the sheet 9000 is maintained in a proper range, so that when the sheet 9000 is folded, the sheet 9000 can slip on the circumferential surface of the rollers 1100, thereby further reducing the risk of tearing the sheet 9000 during the folding process.

The effect obtained by using this device is that it is suitable for folding the sheet 9000 at high speed. For example, the processing speed of the sheet 9000 can reach a range from 100m/min to 350m/min, preferably from 150m/min to 350m/min, and more preferably from 200m/min to 350m/min. It goes without saying that in the sheet folding method of the present application, the tension applied to the sheet 9000 by the rollers 1100 does not exceed the tensile strength of the sheet 9000.

Specifically, only one roller 1100 can float, or both rollers 1100 can float. Appropriate pressure is applied to the floating rollers 1100, so that the two rollers 1100 clamp the sheet 9000 to achieve a balance due to the pressure and the reaction force exerted by the sheet 9000 on the rollers 1100, in such a way the distance between the two rollers 1100 can be dynamically changed in response to the thickness change of the sheet 9000.

It can be understood that the pressure acting on the floating roller 1100 can usually be provided by an elastic member such as a spring, or it can also be provided by other means (for example, using gravity), which is not limited by this application.

It can be understood that in this application, the zigzag folding is realized in a similar way as in the related art, that is, during folding, with the rotation of the rollers 1100, the push component 1110 of one of two rollers 1100 alternately feed a part of the sheet 9000 used for forming crease lines into the clamp component 1120 of the other roller 1100.

And, optionally, in this application, when the sheet 9000 is being pushed in toward the clamp component 1120, the push component 1110 protrudes relative to the circumferential surface of the roller 1100, and after the sheet 9000 is pushed in and attached to the clamp component 1120, the push component 1110 retracts relative to the circumferential surface of the roller 1100. Retracting the push component 1110 in time can avoid the collision between the push component 1110 and another roller 1100, and can also avoid interfering with the clamp component 1120 to clamp the sheet 9000 fed into the clamp component 1120.

It should be emphasized that when the push component 1110 is retracted, the circumferential surfaces of the two rollers 1100 clamp the sheet 9000 from both sides to tension the sheet 9000 during transportation.

By using the sheet folding method of the present application, the force applied to the sheet 9000 during the folding process can be dynamically adjusted, so it is especially suitable for the sheet 9000 with low tensile strength and weak deformability.

In one embodiment, referring to FIG. 3, a sheet 9000 is used to produce an expandable material. Before folding the sheet 9000, a slit 9200 is made on the sheet 9000, and the slit 9200 is inclined to the longitudinal direction. There is an angle between the slit 9200 and the transversely extending crease line 9100.

The folded sheet 9000 of a zigzag shape is suitable for storage in a stacked form, so optionally, the sheet 9000 forms a stack after folding.

The application correspondingly provides a sheet folding apparatus, which can be used for implementing the sheet folding method of the application, and is used for folding the sheet 9000 to form a stack, and at the same time, the risk of accidental tearing of the sheet 9000 can be reduced.

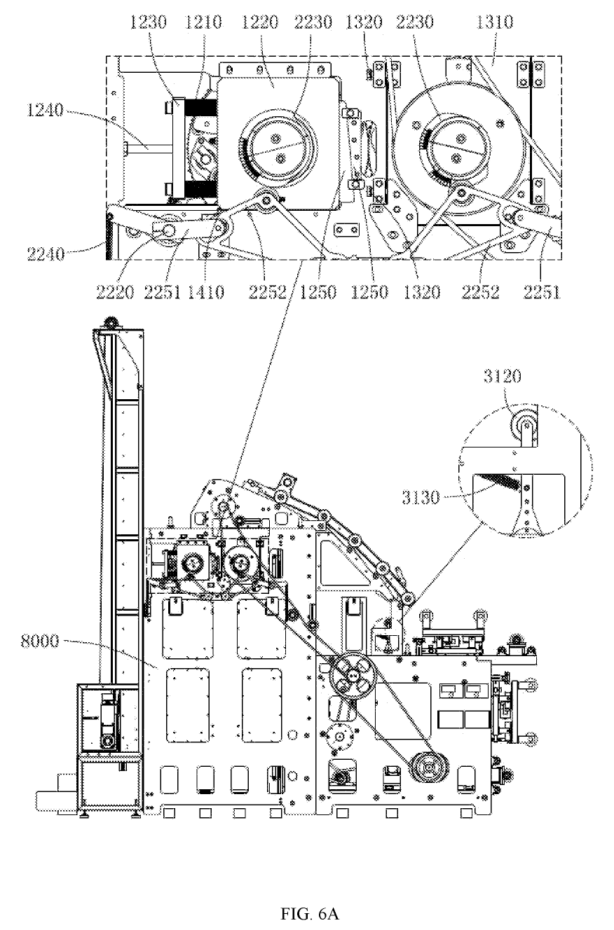

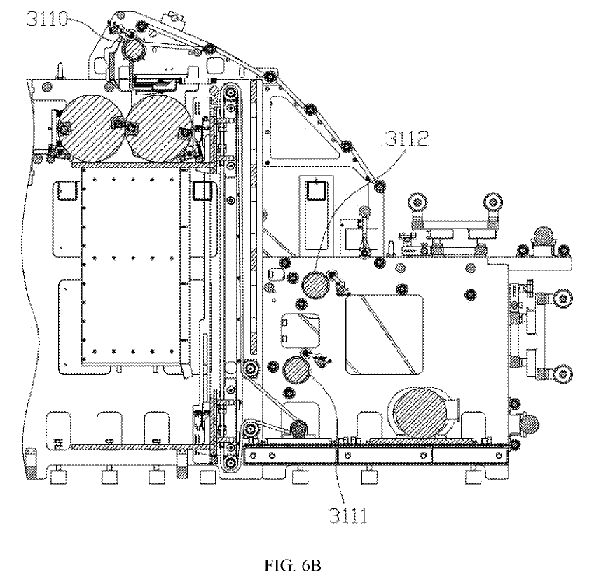

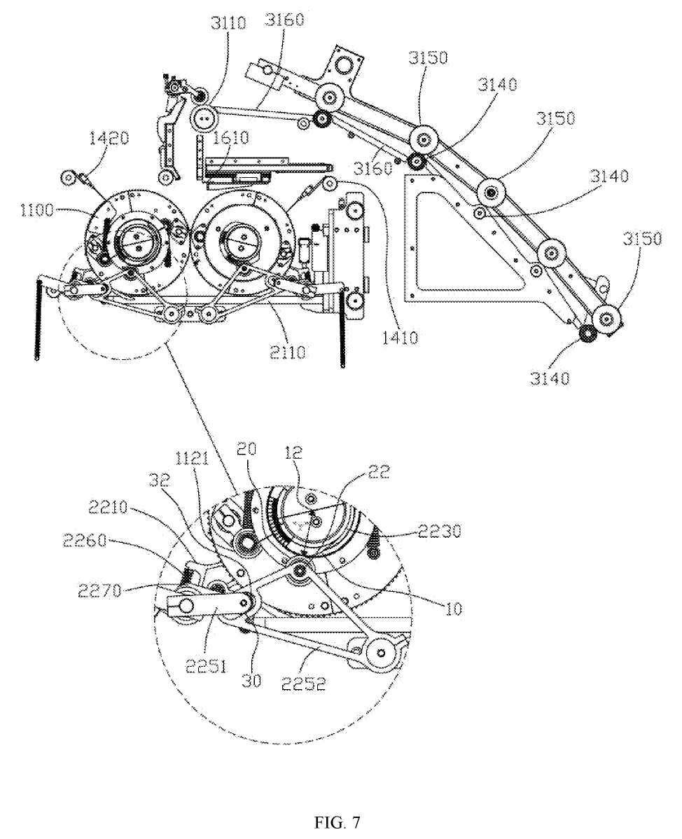

Referring to FIGS. 6A and 7, the sheet folding apparatus provided by the present application includes two rollers 1100 and a first elastic member 1210. The two rollers 1100 are disposed in parallel and opposite each other in a horizontal direction, a conveying channel 1102 is formed between the rollers 1100 for a sheet 9000 to pass through, at least one of the rollers 1100 is movable in the horizontal direction to be close to or away from the other roller 1100, and the rollers 1100 are used for zig-zag folding of the sheet 9000 passing through the conveying channel 1102. The first elastic member 1210 is connected to the movable roller 1100 and used for driving one roller 1100 to move toward the other roller 1100.

It can be understood that in order to achieve folding, the roller 1100 further includes push components 1110 and clamp components 1120, the push components 1110 and the clamp components 1120 are alternately disposed on the roller 1100 in a circumferential direction of the roller 1100, the push component 1110 is able to push the sheet 9000 in the conveying channel 1102 toward the clamp component 1120 of the other roller 1100, and the clamp component 1120 grips the sheet 9000 such that the sheet 9000 moves under the traction of the roller 1100 to facilitate the folding of the sheet 9000.

When processing a sheet material, paper, such as the recycled paper, is usually used as raw material to make a sheet 9000, which leads to a limited ability for elastic deformation. During the pushing process by the push component 1110, if the sheet 9000 on both the upstream and downstream sides of the conveying channel 1102 are clamped by the rollers 1100, the push component 1110 can easily pierce the sheet 9000. For this reason, it is essential for the sheet 9000 to be able to slide on the surface of the rollers 1100. Given that the actual thickness of the sheet 9000 may vary, a thicker sheet 9000 that makes excessive contact with the surface of the rollers 1100 may generate excessive friction during sliding, resulting in tearing.

With a design that allows one of the rollers 1100 to move relative to another, it is possible to adjust the distance between the rollers 1100 in response to a change in thickness of the sheet 9000, thus adjusting the size of the conveying channel 1102. This ensures that the friction exerted by the rollers 1100 on the sheet 9000 does not exceed the tensile strength of the sheet 9000, thus minimizing the risk of tearing the sheet 9000 during the folding process.

It can be understood that the sheet folding apparatus of the present application is suitable for making both a stack of ordinary stock materials and a stack of expandable materials. In the present application, crease lines are made using the clamp components 1120, so perforations are not necessary. However, in scenarios where such a need exists, the sheet folding apparatus may also be equipped with a punch feature, which is not limited by the present application.

In addition, as shown in FIG. 5, the diameter of the rollers 1100 will affect the circumferential distance between the push component 1110 and the clamp component 1120, thus determining the spacing between two adjacent crease lines of the sheet 9000. Therefore, by adjusting the diameter of the rollers 1100, a stack with an appropriate length of each folded sheet can be made to meet the loading requirements of different specifications of transport pallets (half pallet depth (600mm) to full pallet depth (1200mm)).

The present application also provides a stack making device which includes a feeding apparatus and the sheet folding apparatus of the present application, and the feeding apparatus is used for supplying the sheet 9000 to the sheet folding apparatus to produce a stack.

Referring back to the sheet folding apparatus, it can be understood that in the present application, both rollers 1100 may have a degree of freedom of movement in the horizontal direction, or one of the rollers 1100 may be fixed in the horizontal direction, and the other roller 1100 may have a degree of freedom of movement in the horizontal direction. In order to reduce the number of assemblies for driving the rollers 1100, such as a first elastic member 1210, the present application will be described below with reference to an embodiment in which one of the rollers 1100 is fixed in the horizontal direction and the other roller 1100 has a degree of freedom of movement in the horizontal direction.

For convenience of description, the movable roller 1100 may be referred to as a first roller, and the fixedly disposed roller 1100 may be referred to as a second roller.

Optionally, the sheet folding apparatus may further include a frame 8000, a fixed plate 1310 and a movable plate 1220. The movable plate 1220 is movably disposed on the frame 8000, the first roller is rotatably disposed on the movable plate 1220, the fixed plate 1310 is fixedly disposed on the frame 8000, and the second roller is rotatably disposed on the fixed plate 1310.

By actuating the movable plate 1220, the first roller moves horizontally while being able to rotate around its own axis on the movable plate 1220, ensuring that the horizontal movement and rotation of the first roller do not interfere with each other.

The first elastic member 1210 acts on the movable plate 1220, applying a force toward the second roller. It can be understood that different portions of the sheet 9000 have variations in theoretical thickness, tensile strength, and other parameters, so the applied force needs to be adjusted accordingly. Although the force may be adjusted by adopting first elastic members 1210 with different specifications, this would complicate the maintenance of the sheet folding apparatus.

Optionally, the sheet folding apparatus includes a support plate 1230. The support plate 1230 is disposed on the frame 8000 and is adjustable in the horizontal direction. And the first elastic member 1210 is disposed between the support plate 1230 and the movable plate 1220.

By adjusting a position of the support plate 1230, the deformation of the first elastic member 1210 is changed, and then the force received by the movable plate 1220 is adjusted to meet the requirements of different portions of the sheet 9000. Meanwhile, it is also possible to compensate for the aging and fatigue of the first elastic member 1210 by adjusting the support plate 1230, facilitating the use and maintenance of the sheet folding apparatus.

Specifically, referring to FIG. 6A, the support plate 1230 may be disposed on a side, away from the fixed plate 1310, of the movable plate 1220, the first elastic member 1210 may use a compression spring (such as a disc spring). The sheet folding apparatus further includes a mounting rod 1240 connected between the frame 8000 and the support plate 1230, and at least one end of the mounting rod 1240 features a threaded connection, enabling the adjustment of the position of the support plate 1230 by adjusting how far the mounting rod 1240 is screwed in.

The first elastic member 1210 may also use structure features such as tension springs or torsion springs that can provide elastic force, which will not be elaborated on here.

Optionally, in order to avoid excessive proximity between the two rollers 1100, a limit component is used to restrict the position of the rollers 1100.

For example, the sheet folding apparatus includes a first limit component located on a side, close to the second roller, of the movable plate 1220, and the first limit component is arranged to abut against the movable plate 1220 such that a distance between the first roller and the second roller is not less than a preset lower threshold.

For example, referring to FIG. 6A, the first limit component consists of two wedges 1250, with one wedge 1250 (herein referred to as a first wedge) fixed to the frame 8000 and the other wedge 1250 (herein referred to as a second wedge) disposed between the first wedge and the movable plate 1220. The wedges 1250 have inclined surfaces that fit together. By adjusting the vertical position of the second wedge, the movable plate 1220 can be pushed close to or away from the first wedge. This not only achieves limiting but also enables adjustment of the lower threshold based on the specifications of the sheet 9000.

In another example, the sheet folding apparatus includes a second limit component that ensures the correct mounting position of the second roller.

For example, referring to FIG. 6A, the second limit component includes a limit post 1320 disposed on the frame 8000, and the limit post 1320 abuts against the fixed plate 1310, thereby positioning the fixed plate 1310 on the frame 8000. The limit post 1320 may be a limit screw, and the limit screw is disposed on the frame 8000 via a threaded connection, which allows for the adjustment of the position of the fixed plate 1310 by rotating the limit screw.

It can be understood that during folding, there is a risk that the sheet 9000 is not properly released by the clamp component 1120, which may cause the sheet 9000 to wrap around the surface of the roller 1100. During folding, there is also a risk that the folded sheet 9000 is not properly received, leading to a buildup of the sheet 9000 that interferes with the rollers 1100.

Some related arts only check whether the sheet 9000 is wrapped around the surface of the rollers 1100, and fail to timely detect the latter risk. Since the distance between the rollers 1100 can be adjusted in response to changes in the thickness of the sheet 9000, the positions of the rollers 1100 can indicate the operational condition of the sheet folding apparatus.

Optionally, the sheet folding apparatus includes an alarm component. The alarm component includes a first limit switch 1410 disposed on a travel of the movable plate 1220, and the first limit switch 1410 is able to generate an alarm signal in response to a distance between the first roller and the second roller exceeding a preset upper threshold.

On the one hand, when the sheet is wrapped around the surface of the rollers 1100, multiple layers of sheet 9000 pass between the two rollers 1100, causing the position change of the movable plate 1220 to exceed an expected range; on the other hand, when the accumulated sheet 9000 interferes with the rollers 1100, the sheet 9000 may also push the movable plate 1220 to move, causing the position of the movable plate 1220 to change beyond the expected range. By detecting the movable plate 1220 using the first limit switch 1410, the operational condition of the sheet folding apparatus may be more comprehensively reflected.

For example, the first limit switch 1410 may be mechanically triggered to generate an alarm signal. For example, in FIG. 6A, a contact head of the first limit switch 1410 is located on the travel of the movable plate 1220. In response to the position of the movable plate 1220 changing beyond the expected range, the movable plate 1220 actuates the contact head to shift, thereby generating an alarm signal.

Alternatively, the first limit switch 1410 may also perform detection using a photoelectric signal, and a light beam emitted by the first limit switch 1410 is located on the travel of the movable plate 1220. The first limit switch 1410 may also use other feasible triggering methods, which will not be elaborated on here.

In addition to the first limit switch 1410, the alarm component may also include a second limit switch 1420 for detecting whether the sheet 9000 is wrapped around the surface of the roller 1100, and the failure type of the sheet folding apparatus may be efficiently determined by combining the signals sent by the first limit switch 1410 and the second limit switch 1420.

For example, referring to FIGS. 7 and 8A, the roller 1100 is provided with an annular groove 1130 along its circumference, and the second limit switch 1420 faces the annular groove 1130. The second limit switch 1420 may be a distance sensor. In the case where the sheet 9000 is wrapped around the surface of the roller, the annular groove 1130 is blocked, resulting in the second limit switch 1420 detecting a distance change that exceeds a normal movement range of the movable plate 1220, thus producing an alarm signal.

Correct synchronization between the two rollers 1100 is necessary to ensure that the push component 1110 and the clamp component 1120 can cooperate to complete the clamping and folding of the sheet 9000. To this end, the sheet folding apparatus may include transmission gears 1510 mounted on the rollers 1100, and the two transmission gears 1510 mesh with each other, thereby ensuring the synchronization of the two rollers 1100.

Considering that the distance between the two rollers 1100 may vary, a tooth height of the transmission gear 1510 should be greater than a movement range of the rollers 1100 (i.e., the difference between the maximum and minimum distances between the two rollers 1100).

It can be understood that after the clamp component 1120 grips the sheet 9000, the rollers 1100 continues to rotate carrying the sheet 9000, causing the sheet 9000 to be folded. After rotating by a certain angle, the clamp component 1120 releases the sheet 9000 such that the folded sheet 9000 is received downstream.

In this process, if the received sheet 9000 is not fixed, the position of the sheet 9000 is likely to change under the pulling of the roller 1100, resulting in defects such as wrinkles in the stack, thus affecting quality.

It can be understood that a carrier platform 2110 is disposed downstream of the roller 1100 for receiving a stack of the folded sheet 9000.

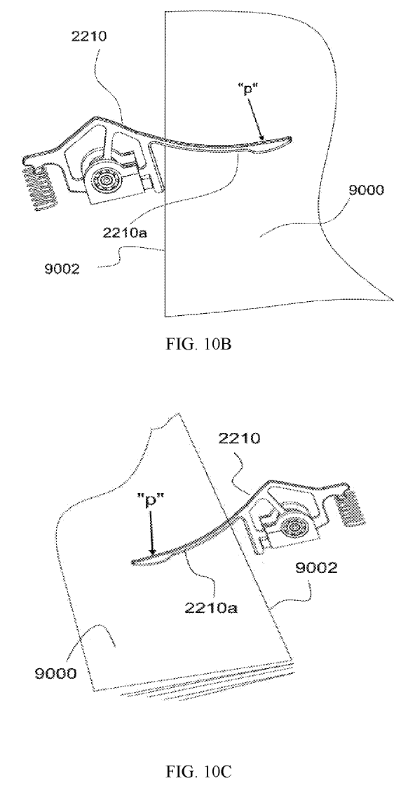

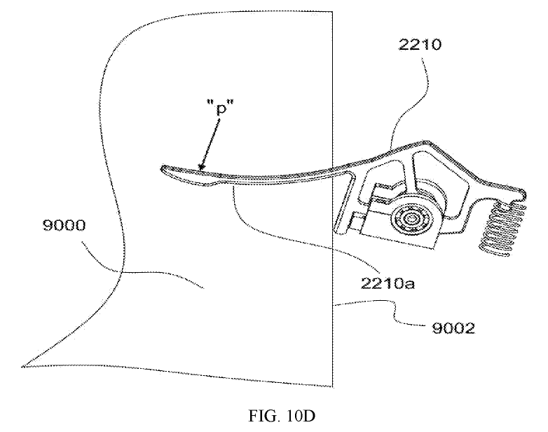

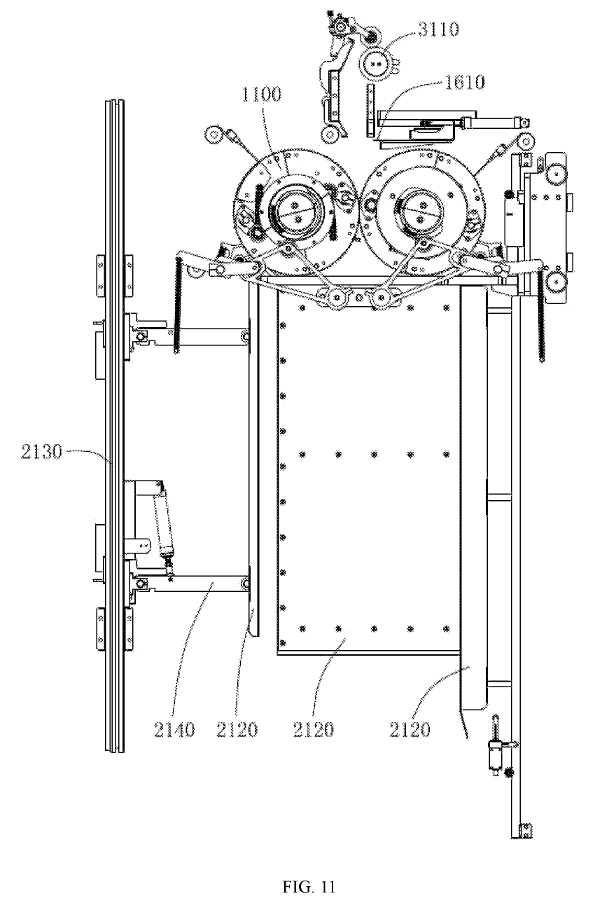

Optionally, referring to FIGS. 7 and 10A, the sheet folding apparatus includes forks 2210, the carrier platform 2110 is located below the rollers 1100, and the two forks 2210 are disposed on two sides of the carrier platform 2110 oppositely in the horizontal direction and used for alternately applying pressure to edges of the stack.

Specifically, one of the forks 2210 (referred to herein as a first fork) is located on the side where the first roller is located and the other fork 2210 (referred to herein as a second fork) is located on the side where the second roller is located.

Referring to FIGS. 10A, 10B,10C, and 10D, as well as FIG. 5, prior to the first roller rotating to move the sheet 9000, with the sheet 9000 being captured and pulled by a clamp component on the first roller, toward an end portion 2210a of the first fork 2210, the first fork 2210 can be positioned with an end portion 2210a disposed upwardly within an annular groove 1130 of the first roller in a ready position, or open position, so that the sheet 9000 (as can be seen in FIG. 10B) can tuck beneath the end portion 2210a of the first fork 2210 as the clamp component pulls it toward the first fork 2210. FIG. 10B is a simplified illustration of the first fork 2210 in such open position (the first roller is not shown in FIG. 10B, for simplicity of illustration only, but it can be seen in FIG. 5, which shows the first fork 2210 with an end portion 2210a receded within an annular groove of the first roller on the left side of the illustration in FIG. 5). Simultaneously therewith, the second fork 2210, disposed proximate the second roller, is disposed in a downward position, with an end portion 2210a of the second fork 2210 having dropped downward from within an annular groove 1130 of the second roller to press downward against the opposite edges of the stack (as can be seen in FIGS. 10C and 5), applying a force “p” on the stack of sheets 9000 opposite to that of the first roller. The second fork 2210, as illustrated in FIG. 10C, has moved to the downward position in FIG. 10C, from an open position (such as that shown in FIG. 10D) after the sheet 9000 was moved beneath it by the second roller pulling the sheet 9000 via a clamp component thereon in conjunction with the sheet being pushed by being compressed between the moving first roller and moving second roller. The end portion 2210a of the second fork 2210 then descended downward against the sheet 9000 to push it downward, as illustrated by the application of force “p” in FIG. 10C, thereby facilitating the generation and stabilization of the crease line 9002 therein as the sheet 9000 has folded back on itself. The second roller is also not illustrated in FIG. 10C, for simplicity of illustration only. The application of force “p” as shown in FIG. 10C also helps keeps the sheet 9000 already received by the carrier platform 2110 in place and also provides a tension to prevent the currently folded sheet 9000 from wrinkling.

Thereafter, as the rollers continue to rotate, another portion of the sheet 9000 is now clamped on a clamp component of the first roller and pulled and pushed toward the first fork component 2210, while the first fork component is in the open position as shown in FIG. 10B, until the crease 9002 portion thereof is disposed beneath the first fork 2210 and first fork end portion 2210a, at which time, the first fork 2210 will descend downward with force “p” (See, e.g., FIG. 10B) to push the sheet 9000 and crease 9002 portion downward onto the sheet stack until first fork component assumes a downward position (substantially similar to that assumed by the second fork in FIG. 10C), and at the same time, the second fork opens to be ready to receive the sheet 9000, as can be seen in FIG. 10D, and so on, and so forth, with the forks on opposite rollers thereby alternately applying pressure to the edges of the stack 9003 on an alternating basis, in coordination with the zig-zag folding of the sheet 9000.

It can be understood that the movement of the forks 2210 needs to be synchronized with the rotation of the rollers 1100 and, optionally, the sheet folding apparatus includes a synchronization component through which the forks 2210 are connected to the rollers 1100, allowing the movement of the forks 2210 to be coupled with the rotation of the rollers 1100.

For example, referring to FIG. 10A, the sheet folding apparatus includes rotatable second shafts 2220 extending parallel to the rollers 1100, and the forks 2210 are disposed on the second shafts 2220. The synchronization component achieves synchronization between the forks 2210 and the rollers 1100 by coupling the rotation of the second shafts 2220 and the rotation of the rollers 1100.

Specifically, coupling of the rotation of the second shafts 2220 and the rotation of the rollers 1100 may be achieved by a cam.

For example, the synchronization component may include a cam 2230, a link mechanism and a second elastic member 2240, the cam 2230 is disposed on the roller 1100, the link mechanism is disposed on the second shaft 2220, and the second elastic member 2240 is used for driving the link mechanism to abut against the cam 2230, so as to enable the second shaft 2220 to rotate in response to the rotation of the cam 2230.

It should be noted that, considering that the rollers 1100 can move horizontally, the synchronization component needs to compensate for the position change of the rollers 1100 to ensure that the synchronization between the rollers 1100 and the forks 2210 remains stable while the position change of the rollers 1100 occurs.

Optionally, referring to FIG. 7, the link mechanism includes a first link 2251 and a second link 2252. The first link 2251 is fixedly disposed on the second shaft 2220, the second link 2252 is rotatably disposed on the frame 8000, the second link 2252 abuts against the cam 2230, and the first link 2251 and the second link 2252 are slidably connected. As the rollers 1100 moves, the first link 2251 is able to slide with respect to the second link 2252, thereby providing compensation.

Continuing to refer to FIG. 7, in some embodiments, the cam 2230 has an abutting surface 10, that abuts against a link roller 20 of the second link 2252. The link roller 20 rotates about an axis element 22 attached to the second link 2252. The abutting surface 10 of the cam 2230 has a variable radius distance “r” from the center 12 of the cam 2230 (about which the cam 2230 rotates) to the abutting surface of the link roller 20, such that, as the cam 2230 rotates, an axis of the link roller 20 remains stationary while “r” remains the same, but then the axis of the link roller 20 is displaced as a function of change in “r,” thereby causing the first link 2251 to move, then in, in turn, the second shaft 2220 to partially rotate against a tension of the elastic member 2240, in order to contribute to a synchronization of a position of the forks 2210 thereon.

Also, specifically, in the embodiment shown in FIG. 7, a sliding groove 30 is formed in the second link 2252, and a slide block 32 is disposed on the first link 2251. The first link 2251 is in a sliding connection with the second link 2252 by the slide block 32 in the sliding groove 30. When the roller 1100 moves horizontally, a contact point between the link roller 20 of the second link 2252 and the cam 2230 may change, resulting in a slight angular variation of the second link 2252. By designing an appropriate groove shape, the sliding groove may compensate for the changes in the second link 2252, allowing the first link 2251 to remain stable.

It should also be noted that since the cam 2230 is disposed on the roller 1100 and rotates with the roller 1100, which may cause a shift of the center of gravity of the cam 2230 and affect the rotational stability of the roller 1100.

For this reason, it is necessary to position the center of gravity of the cam 2230 as close as possible to the axis of rotation. One optional method is to perform dynamic balancing calibration on the cam 2230, while another method is to reduce the diameter variation of the cam 2230.

For the latter method, optionally, a distance from a position where the second link 2252 abuts against the cam 2230 to a rotational shaft of the second link 2252 is defined as a first distance, a distance from a position where the second link 2252 is connected to the first link 2251 to the rotational shaft of the second link 2252 is defined as a second distance, and the second distance is larger than the first distance. The second link 2252 is suitable for actuating the second shaft 2220 to rotate in a larger range through the cam 2230 with a smaller diameter change.

The above only illustrates one implementation that utilizes the synchronization component to couple the movement of the forks 2210 with the rotation of the rollers 1100. Based on the design concepts of the present application, other synchronization component design schemes may also be adopted. For example, the cam may also be disposed on the frame 8000, and the fork 2210 and the rollers 1100 are connected to the cam through different link mechanisms, which will not be elaborated on here.

In addition to pressing against the sheet 9000, optionally, the fork 2210 extends its end into the annular groove 1130 when opened. As the roller 1100 rotates, the sheet 9000 moves beneath the end of the fork 2210. After the roller 1100 releases the sheet 9000, the fork 2210 presses down to assist the roller 1100 in pushing out the sheet 9000.

For example, the second elastic member 2240 may also be used to drive the end of the fork 2210 into the annular groove 1130.

Specifically, in the embodiment shown in FIG. 7, the second elastic member 2240 applies a torque to the second shaft 2220, with the torque being oriented in a direction that causes the fork 2210 to release the sheet 9000. On the one hand, the torque generated by the second elastic member 2240 causes the fork 2210 to open until the end abuts against the roller 1100, and on the other hand, the rotation of the second shaft 2220 acts on the second link 2252 through the link mechanism, ensuring that the second link 2252 abuts against the cam 2230.

It should be noted that, considering that there are certain errors in the installation of the forks 2210 and the link mechanism, it is necessary to provide a compensation structure to ensure that the second link 2252 abuts against the cam 2230 while the fork 2210 abuts against the roller 1100.

Optionally, the fork 2210 may have certain deformation ability, compensating for the mounting errors between the link mechanism and the second shaft 2220 through its elastic deformation. When the fork 2210 abuts against the roller 1100 and the second link 2252 has not yet abutted against the cam 2230, the fork 2210 deforms to allow for further rotation of the second shaft 2220 until the second link 2252 abuts against the cam 2230.

Alternatively, compensation may also be achieved through sliding connection in the link mechanism (for example, sliding connection between the first link 2251 and the second link 2252). When the second link 2252 abuts against the cam 2230 but the fork 2210 has not yet abutted against the roller 1100, the sliding of the first link 2251 relative to the second link 2252 allows the second shaft 2220 to rotate further until the fork 2210 abuts against the roller 1100.

Both compensation approaches may be used in combination to ensure that the second elastic member 2240 reliably works in both ways.

Optionally, the fork 2210 is movably disposed on the second shaft 2220, the sheet folding apparatus includes third elastic members 2260 disposed between the forks 2210 and the second shafts 2220. The third elastic member 2260 is used for providing a compression force.

That is, the third elastic member 2260 drives the fork 2210 toward the stack. Under the actuation of the cam 2230, the fork 2210 presses against the sheet 9000. The force exerted by the fork 2210 on the sheet 9000 cannot be larger than the force provided by the third elastic member 2260, otherwise, the fork 2210 may move reversely against the force of the third elastic member 2260, so that the force of the fork 2210 on the sheet 9000 is balanced with the force provided by the third elastic member 2260 again. This helps prevent excessive force on the sheet 9000, which may cause the tension to exceed its tensile strength.

Preferably, the fork 2210 generates a compression force against the sheet 9000 in the range of 0.2 kgf to 10kgf, preferably 0.5 kgf to 10kgf, and more preferably 0.5 kgf to 5 kgf.

For example, referring to FIG. 10A, the sheet folding apparatus may include fork seats 2270 and shaft seats 2280. The fork seats 2270 are disposed on the second shafts 2220, the shaft seats 2280 are disposed on the fork seat 2270 at an interval in an axial direction of the second shaft 2220, and the fork 2210 is rotatably disposed on the shaft seat 2280. The third elastic member 2260 is a compression spring that abuts between the fork seat 2270 and the fork 2210 to drive the fork 2210 toward the stack.

In addition, a buffer structure may be provided between the fork seat 2270 and the fork 2210, for example, a cushion block may be provided on the fork seat 2270, thereby avoiding rigid collision between the fork 2210 and the fork seat 2270 and reducing noise.

Optionally, the carrier platform 2110 is able to move vertically. As the height of the stack increases, the carrier platform 2110 gradually descends, maintaining a consistent distance between a top surface of the stack and the roller 1100, thereby improving the quality consistency of the stack.

In addition, the sheet folding apparatus may be provided with a first cutter 1610 disposed upstream of the roller 1100, and when the stack on the carrier platform 2110 reaches a suitable size, the first cutter 1610 is controlled to extend and cut the sheet 9000 to finish the production of a stack. Referring to FIG. 8D, this cutter has a telescopic structure, which may effectively shorten the size of the cutter, so as to facilitate the cut sheet to re-enter the conveying channel of the roller 1100 and automatically continue to produce the next stack.

The sheet folding apparatus may also be provided with a second cutter (not shown) disposed upstream of the roller 1100 for machining a slit for expansion in the sheet 9000, allowing the sheet 9000 to be manufactured as expandable material.

Optionally, the sheet folding apparatus includes shaping plates 2120 encircling the carrier platform 2110, and the shaping plate 2120 is arranged to contact and restrict the stack, thereby further improving the quality consistency of the stack.

Optionally, the sheet folding apparatus defines a manufacturing chamber, and the carrier platform 2110 and the shaping plates 2120 are located in the manufacturing chamber. The manufacturing chamber can provide sound insulation while also preventing external contaminants from polluting the stack during the manufacturing process.

The manufacturing chamber can be opened to allow the manufactured stack to be taken out. For example, the sheet folding apparatus further includes a movable door panel 2130 capable of opening or closing the manufacturing chamber. The shaping plate 2120 is disposed on the door panel 2130, that is, located on the same side of the door panel 2130. In this way, the shaping plates 2120 are simultaneously opened as the door panel 2130 being opened, thereby optimizing the actions required to remove the stack.

Specifically, referring to FIGS. 6A and 11, the door panel 2130 can open or close the manufacturing chamber by moving vertically, the shaping plate 2120 is connected to the door panel 2130 via a swing rod 2140, and the swinging of the swing rod 2140 allows the shaping plate 2120 to approach or move away from the door panel 2130.

When the door panel 2130 is open, the shaping plate 2120 is close to the door panel 2130 so as not to interfere with other parts of the sheet folding apparatus, and when the door panel 2130 is closed, the shaping plate 2120 is away from the door panel 2130 so as to contact and restrict the stack.

It may be understood that with reference to FIG. 6B, the third convey component 3111 and the fourth convey component 3112 are driving rollers configured to drive and convey the sheet to the buffer. In order to ensure that the sheet is neither wrinkled nor torn, the friction force generated of sliding friction occurred between the sheet and the third convey component(or the fourth convey component) is not greater than the tensile strength of the sheet.

It can be understood that, with reference to FIG. 7, a first convey component 3110 is provided upstream of the roller 1100, the first convey component 3110 is a driving member, and the sheet 9000 is conveyed to the rollers 1100 by the first convey component 3110.

Given the risk of tearing the sheet 9000 during conveyance, it is necessary to ensure that a frictional force applied by the first convey component 3110 to the sheet 9000 does not exceed the tensile strength of the sheet 9000.

Specifically, when the push component 1110 acts on the sheet 9000, the sheet 9000 slides, and the convey speed will fluctuate. In this case, the frictional force provided by the first convey component 3110 can be limited, so that in response to the applied force being too large, sliding occurs between the first convey component 3110 and the sheet 9000, preventing the first convey component 3110 from tearing the sheet 9000.

That is, in the stack making method, the tension applied to the strip may be controlled by controlling the frictional force applied to the strip by the first convey component 3110 during conveyance of the strip.

Optionally, the frictional force applied by the first convey component 3110 to the sheet 9000 is controlled by at least one of the following steps: adjusting a skin friction coefficient of the first convey component 3110, for example, selecting a material with suitable frictional properties as the surface of the first convey component 3110; adjusting a contact area between the sheet 9000 and the first convey component 3110, for example, using a cylindrical roller as the first convey component 3110 and adjusting a wrap angle of the sheet 9000 around the roller to a suitable value; and adjusting a force that presses the sheet 9000 against the first convey component 3110.

Further, the sheet folding apparatus includes a buffer 3120 and a fourth elastic member 3130. The fourth elastic member 3130 is used for making the buffer 3120 resiliently press against the sheet 9000 to buffer or release the sheet in response to a change in tension of the sheet.

On the one hand, the buffer 3120 may compensate for the sliding of the sheet 9000 by buffering and releasing the sheet 9000, ensuring that the sheet 9000 is always in a proper tension state; on the other hand, the buffer 3120 may also function as an isolator to prevent the speed fluctuation of the sheet 9000 from affecting the upstream feeding apparatus providing the sheet 9000.

As can be understood, in order to improve production efficiency and space utilization, the produced stack tends to have a considerable height, so the roller 1100 for folding the sheet 9000 and the first convey component 3110 for conveying the sheet 9000 to the roller 1100 are also located at a high position. In the initial stage of manufacturing, it is necessary to provide a head portion of the sheet 9000 to the first convey component 3110, and the manual climbing operation has certain safety hazards and is cumbersome.

Optionally, the sheet folding apparatus includes guide rollers 3140 and a second convey component 3150. The guide rollers 3140 are located upstream of the first convey component 3110, the plurality of guide rollers 3140 are inclined from bottom to top along a convey route of the sheet 9000 to form an upwardly inclined feeding channel, the second convey component 3150 is able to move close to or away from the guide rollers 3140, and the second convey component 3150 is used for driving the sheet 9000 to be conveyed along the feeding channel.

When the sheet 9000 is loaded, the head portion of the sheet 9000 is first placed on the guide rollers 3140, then the second convey component 3150 is pressed against the sheet 9000, and the second convey component 3150 pushes the sheet 9000 across the feeding channel to the first convey component 3110.

After the loading of the sheet 9000 is completed, the second convey component 3150 is removed so as to prevent the second convey component 3150 and the first convey component 3110 from interfering with each other.

It should be noted that there must be a gap between the adjacent guide rollers 3140, otherwise, the rotation of the guide rollers 3140 may interfere with each other, posing a risk that the head portion of the sheet 9000 may get stuck in the gap between the guide rollers 3140 and fail to reach the first convey component 3110 smoothly.

For this purpose, the sheet folding apparatus may further include deflectors 3160 extending between every two adjacent guide rollers 3140.

The deflector 3160 is located below a conveying surface defined by the two adjacent guide rollers 3140, so that the sheet 9000 does not come into contact with the deflector 3160 after being tensioned, thereby reducing the frictional resistance of the feeding channel and reducing the risk of tearing of the sheet 9000.

In some optional embodiments, the functions/operations mentioned in the block diagram may not be performed in the order mentioned in the operation diagram. For example, depending on the functions/operations involved, two blocks shown in succession may in fact be performed substantially simultaneously or the two blocks may sometimes be performed in reverse order. Further, the embodiments presented and described in the present application are provided by way of example in order to provide a more comprehensive understanding of the techniques. The disclosed method is not limited to the operations and logical flows presented herein. Optional embodiments are contemplated in which the order of various operations is changed and in which sub-operations described as part of a larger operation are performed independently.

Although the embodiments of the present application have been shown and described, it can be understood by those of ordinary skill in the art that various changes, modifications, substitutions and variations may be made to these embodiments without departing from the principles and objectives of the present application, and the scope of the present application is defined by the claims and their equivalents.

### LIST OF REFERENCE NUMERALS

The following is a list of reference numbers: roller 1100, push component 1110, clamp component 1120, roller 1121, cam 1122, damping material 1123, annular groove 1130, first elastic member 1210, movable plate 1220, support plate 1230, mounting rod 1240, wedge 1250, fixed plate 1310, limit post 1320, first limit switch 1410, second limit switch 1420, transmission gear 1510, first cutter 1610;

carrier platform 2110, shaping plate 2120, door panel 2130, swing rod 2140, fork 2210, second shaft 2220, cam 2230, second elastic member 2240, first link 2251, second link 2252, third elastic member 2260, fork seat 2270, shaft seat 2280, cushion block 2290;

first convey component 3110, buffer 3120, fourth elastic member 3130, guide roller 3140, second convey component 3150, deflector 3160, third convey component 3111, fourth convey component 3112;

frame 8000; and

sheet 9000, crease line 9100, slit 9200.

What is claimed is:

1. A sheet stack, comprising
a sheet extending in a length direction, wherein the sheet is folded in a zigzag pattern, at a predetermined interval along the length of the sheet, and about a crease line extending in a direction orthogonal to the length direction, thereby producing a stack made of crease lines that are free of perforations, or substantially free of perforations.

2. The sheet stack according to claim 1, wherein the stack has a height less than or equal to three times the predetermined interval, preferably less than or equal to 2.5 times the predetermined interval, and more preferably less than or equal to 2 times the predetermined interval.

3. The sheet stack according to claim 1, wherein a length of each folded sheet of the stack is 280mm to 1200mm, preferably 400mm to 1200mm, and more preferably 500mm to 1200 mm.

4. The sheet stack according to claim 1, wherein a width of the sheet is 300mm to 1200mm, preferably 400mm to 1200mm, and more preferably 500mm to 1200 mm.

5. The sheet stack according to claim 1, wherein the sheet comprises expansion lines parallel or inclined to crease lines of the sheet, the expansion lines are disposed at an interval in the length direction with slits thereon that penetrate the sheet, and the slits on adjacent expansion lines are arranged in an offset manner.

6. A sheet folding method, comprising:
arranging two rollers in parallel with a conveying channel therebetween,
clamping a sheet in the conveying channel by the two rollers, as the two rollers rotates, the sheet is transferred downstream and folded to form a stack of a zigzag shape,
wherein at least one of the two rollers is floatable relative to the other roller in such a way that a distance between the two rollers changes in response to a thickness variation of the sheet.

7. The sheet folding method according to claim 6, wherein the sheet is conveyed at a speed range of 100-350m/min, preferably 150-350m/min, and more preferably 200- 350m/min.

8. The sheet folding method according to claim 6, wherein a tension applied to the sheet by the two rollers does not exceed a tensile strength of the sheet.

9. The sheet folding method according to claim 6, wherein the two rollers comprise a first roller and a second roller, and with the rotation of the two rollers, a push component of the first roller pushes the sheet in the conveying channel into a clamp component of the second roller, and a push component of the second roller pushes the sheet in the conveying channel into a clamp component of the first roller.

10. The sheet folding method according to claim 9, wherein when the sheet is pushed in toward the clamp component, the push component protrudes relative to a circumferential surface of the roller, and after the sheet is pushed in to the clamp component, the push component retracts relative to the circumferential surface of the roller.

11. The sheet folding method according to claim 6, wherein a slit is made on the sheet before entering the conveying channel, and the slit is inclined to a length direction of the sheet.

12. The method for folding sheets according to claim 6, wherein the sheet forms a stack after being folded.

13. A sheet folding apparatus, comprising:
two rollers disposed in parallel and opposite each other in a horizontal direction, a folding channel being formed between the two rollers for a sheet to pass through, at least one of the two rollers being movable in the horizontal direction to be close to or away from the other roller, and the rollers being arranged to pass and fold the sheet through the folding channel to form a stack of a zigzag shape; and
a first elastic member connected to the movable roller and arranged to drive the movable roller to move toward the other roller.

14. The sheet folding apparatus of claim 13, wherein the two rollers comprise a movable first roller and a fixed second roller.

15. The sheet folding apparatus of claim 14, wherein the sheet folding apparatus comprises a frame, a fixed plate and a movable plate, the movable plate is movably disposed on the frame, the first roller is rotatably disposed on the movable plate, the fixed plate is fixedly disposed on the frame, and the second roller is rotatably disposed on the fixed plate.

16. The sheet folding apparatus of claim 15, wherein the sheet folding apparatus comprises a support plate disposed on the frame, and a position of the support plate in the horizontal direction is adjustable, and the first elastic member is disposed between the support plate and the movable plate.

17. The sheet folding apparatus of claim 15, wherein the sheet folding apparatus comprises a first limit component located on a side, close to the second roller, of the movable plate, and the first limit component is arranged to abut against the movable plate such that a distance between the first roller and the second roller is not less than a preset lower threshold.

18. The sheet folding apparatus of claim 15, wherein the sheet folding apparatus comprises an alarm component, the alarm component comprises a first limit switch disposed on a travel of the movable plate, and the first limit switch is capable of generating an alarm signal in response to a distance between the first roller and the second roller exceeding a preset upper threshold.

19. The sheet folding apparatus of claim 18, wherein the alarm component comprises a second limit switch, the roller is provided with an annular groove along its own circumference, the second limit switch faces the annular groove, and the second limit switch is capable of generating an alarm signal in response to the sheet being wrapped around the rollers.

20. The sheet folding apparatus of claim 13, wherein the sheet folding apparatus comprises two transmission gears mounted on the rollers, the two transmission gears mesh with each other, and a tooth height of the transmission gear is greater than a movement range of the roller.

21. The sheet folding apparatus of claim 13, wherein the sheet folding apparatus comprises a carrier platform and forks, the carrier platform is located below the rollers and used for receiving a stack of the folded sheet, and two forks are disposed on two sides of the carrier platform oppositely in the horizontal direction and used for alternately applying pressure to edges of the stack.

22. The sheet folding apparatus of claim 13, wherein the sheet folding apparatus comprises a synchronization component through which the forks are connected to the rollers, allowing the movement of the forks to be coupled with the rotation of the rollers.

23. The sheet folding apparatus of claim 22, wherein the sheet folding apparatus comprises a rotatable second shaft extending parallel to the roller, and the forks are disposed on the second shaft.

24. The sheet folding apparatus of claim 23, wherein the synchronization component comprises a cam, a link mechanism and a second elastic member, the cam is disposed on the roller, the link mechanism is disposed on the second shaft, and the second elastic member is arranged to drive the link mechanism to abut against the cam, so as to enable the second shaft to rotate in response to the rotation of the cam.

25. The sheet folding apparatus of claim 24, wherein the link mechanism comprises a first link and a second link, the first link is fixedly disposed on the second shaft, the second link is rotatably disposed on the frame, the second link abuts against the cam, and the first link and the second link are slidably connected.

26. The sheet folding apparatus of claim 25, wherein a distance from a position where the second link abuts against the cam to a rotational shaft of the second link is defined as a first distance, a distance from a position where the second link is connected to the first link to the rotational shaft of the second link is defined as a second distance, and the second distance is larger than the first distance.

27. The sheet folding apparatus of claim 26, wherein the roller is provided with an annular groove along its own circumference, a position of the annular groove is aligned with a position of the fork, and the second elastic member is arranged to drive an end of the fork to extend into the annular groove, allowing the fork to push out the sheet during compression.

28. The sheet folding apparatus of claim 27, wherein the fork is elastically deformable to compensate for the changes in the distance between the stack and the roller and the amount of deformation caused by the variation of tightness of the stack.

29. The sheet folding apparatus of claim 24, wherein the fork is movably disposed on the second shaft, the sheet folding apparatus comprises a third elastic member disposed between the fork and the second shaft, and the third elastic member is used for providing a compression force.

30. The sheet folding apparatus of claim 29, wherein the fork generates a compression force against the sheet in the range of 0.2 kgf to 10kgf, preferably 0.5 kgf to 10kgf, and more preferably 0.5 kgf to 5 kgf.

31. The sheet folding apparatus of claim 21, wherein the sheet folding apparatus comprises shaping plates surrounding the carrier platform, and the shaping plate is used for contacting and restricting the stack.

32. The sheet folding apparatus of claim 31, wherein the sheet folding apparatus defines a manufacturing chamber, the carrier platform and the shaping plates are located in the manufacturing chamber, the sheet folding apparatus further comprises a movable door panel capable of opening or closing the manufacturing chamber, and the shaping plates located on the same side of the door panel are disposed on the door panel.

33. The sheet folding apparatus of claim 13, wherein the sheet folding apparatus comprises a first convey component disposed upstream of the roller for conveying the sheet to the rollers.

34. The sheet folding apparatus of claim 33, wherein a frictional force applied by the first convey component to the sheet does not exceed a tensile strength of the sheet.

35. The sheet folding apparatus of claim 34, wherein the frictional force applied by the first convey component to the sheet is controlled by at least one of the following ways: adjusting a skin friction coefficient of the first convey component; adjusting a contact area between the sheet and the first convey component; and adjusting a force that presses the sheet against the first convey component.

36. The sheet folding apparatus of claim 35, wherein the sheet folding apparatus comprises a buffer and a fourth elastic member, and the fourth elastic member is used for making the buffer resiliently press against the sheet to buffer or release the sheet in response to a change in tension of the sheet.

37. The sheet folding apparatus of claim 36, wherein the sheet folding apparatus comprises a plurality of guide rollers and a second convey component, the plurality of guide rollers are located upstream of the first convey component and inclined from bottom to top along a convey route of the sheet to form an upwardly inclined feeding channel, the second convey component is capable of moving close to or away from the guide rollers, and the second convey component is used for driving the sheet to be conveyed along the feeding channel.

38. The sheet folding apparatus of claim 37, wherein the sheet folding apparatus comprises deflectors extending between every two adjacent guide rollers, and the deflector is located below a conveying surface defined by the two adjacent guide rollers.

39. The sheet folding apparatus of claim 13, wherein the sheet folding apparatus comprises a clamp component, and the clamping assembly is provided with a damping material.

40. The sheet folding apparatus of claim 13, wherein the sheet folding apparatus comprises a cam and a roller arranged for pushing the clamp component and the push component, and either of the cam or the roller adopts a damping material.

41. The sheet folding apparatus of claim 13, wherein the sheet folding apparatus comprises a first cutter, and the paper is cut in a folding process through a push-pull movement to complete a paper stack production.

42. The sheet folding apparatus of claim 41, wherein the paper cut by the first cutter is capable of automatically entering the conveying channel of the roller to continue the next paper stack production.

43. The sheet folding apparatus of claim 13, wherein the sheet folding apparatus comprises driving rollers, and the friction force of sliding friction between each driving roller and the sheet is less than the tensile strength of the sheet.

44. A stack making device, wherein the stack making device comprises a feeding apparatus and the sheet folding apparatus according to claim 13, and the feeding apparatus is used for supplying the sheet to the sheet folding apparatus.
